(19) United States
(12) Patent Application Publication
(10) Pub. No.: US 2006/0132489 A1
(43) Pub. Date: Jun. 22, 2006

(54) Remote computing

(75) Inventor: Bruce Eric Blaho, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/018,033

(22) Filed: Dec. 21, 2004

(51) Int. Cl. G06T 1/00

(52) U.S. Cl. 345/501

(57) ABSTRACT

A graphic processor is connected to a main processor in a client device or in a host computer. The graphics processor executes software to to perform at least a portion of remote computing overhead associated with the remote computing session.

### BACKGROUND

Current remote client access technologies use a general purpose host computer or specialized add-on hardware to perform remote computing. Examples of host-based software solutions include X Windows and Microsoft Remote Desktop. Examples of special purpose hardware-based solutions include products from ClearCube and 2C Computing.

Host-based software solutions may impact the performance of the host computer. Performance in host-based software solutions is limited by the speed of the host CPU and the time required to load program instructions in the host CPU. In addition, the overhead of performing remote computing hobbles the host CPU, stealing cycles from the host applications.

Dedicated hardware solutions add cost and complexity. In addition, the specialized hardware application is typically limited to a short distance (usually 500-600 feet) and may require dedicated wiring between the local and remote machines. Furthermore, such applications usually have limited graphics resolution and multithread capability (typically 4 threads or less of 1280×1024 pixel resolution).

### BRIEF DESCRIPTION OF THE DRAWINGS

In the drawings, which are not necessarily drawn to scale, like reference numerals describe substantially similar components throughout the several views. The drawings illustrate generally, by way of example, but not by way of limitation, various embodiments discussed in the present document.

FIGS. 1 and 2 illustrate embodiments of computers which may be used to perform remote computing;

FIG. 3 illustrates one embodiment of a remote computing system;

FIG. 4 illustrates a method of accelerating remote computing according to an embodiment; and

FIG. 5 illustrates another embodiment of a remote computing system.

### DESCRIPTION OF THE EMBODIMENTS

Modern graphics processors are capable of performing more than the graphics computations for which they were designed. They are now capable coprocessors, and their high speed makes them useful for a variety of applications. A system and method for using the graphics processor to accelerate remote computing is described below.

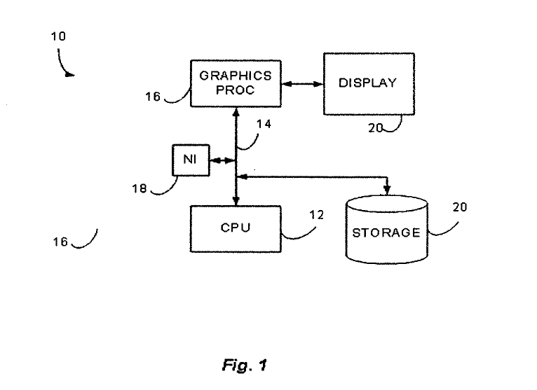

A computer system 10 which may be used to perform remote computing is shown in FIG. 1. In the computer system of FIG. 1, a processor (CPU) 12 is connected across a bus 14 to a graphics processor 16, a network interface (NI) 18 and a storage device (storage) 20. Network interface 18 is capable of being connected to a network (not shown). In one embodiment, graphics processor 16 is connected to display 22. Bus 14 is a common pathway, or channel, between multiple devices. It may be a parallel or serial bus.

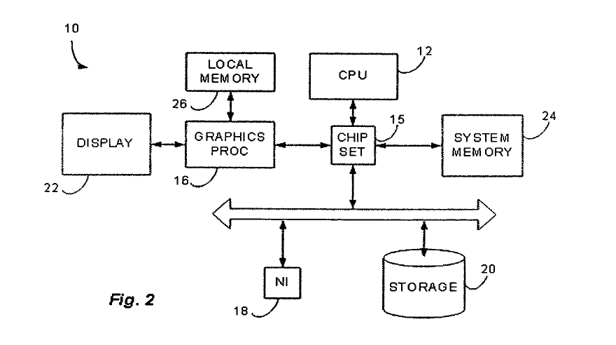

One example embodiment of computer system 10 is shown in FIG. 2. In computer system 10 of FIG. 2, a processor 12 is connected through chipset 15 to graphics processor 16, a network interface 18, storage device 20 and system memory 24. Network interface 18 is capable of being connected to a network (not shown). In one embodiment, processor 12 communicates with network interface 18 and storage device 20 over a Peripheral Component Interconnect (PCI) bus 25.

In one embodiment, graphics processor 16 is connected to display 22 and local memory 26 and communicates with processor 12 and system memory 24 through an Accelerated Graphics Port (AGP) (not shown).

AGP gives the graphics processor 16 the ability to access system memory 24 directly for the complex operation of texture mapping. AGP provides a graphics card with two methods of directly accessing texture maps in system memory: pipelining and sideband addressing. In pipelining, AGP makes multiple requests for data during a bus or memory access. PCI makes one request in pipelining, and does not make another until the data it requested has been transferred.

In another embodiment, graphics processor 16 communicates with processor 12 and system memory 24 using PCI Express. Other peripheral interconnect schemes could be used as well.

In the systems of FIGS. 1 and 2, graphics processor 16 performs the complex compression algorithms and pixel read-back used for remote computing. In contrast to host-based systems, processor 12 does not have to read back screen pixels before image processing may begin. Instead, the graphics processor already has high-speed access to the pixels. Modern 3D graphics accelerators have sufficient processing power to perform image processing algorithms, including compression and decompression, in effect moving that process from the CPU to the graphics processor.

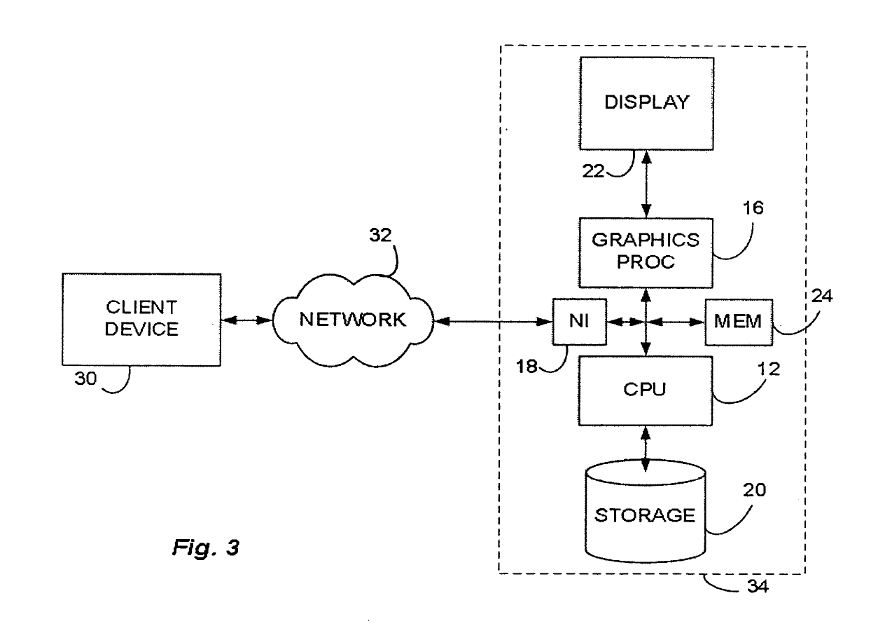

FIG. 3 illustrates an embodiment of a remote computing system including a client device 30 connected across a network 32 to a host system (e.g. computer) 34. In the embodiment shown, a processor 12 is connected to graphics processor 16, a network interface 18, storage device 20 and system memory 24. Network interface 18 is connected to network 32. In one embodiment, processor 12 communicates with network interface 18 and storage device 20 over a Peripheral Component Interconnect (PCI) bus.

In one embodiment, graphics processor 16 is connected to display 22 and communicates with processor 12 and system memory 24 through an Accelerated Graphics Port (AGP). In another embodiment, graphics processor 16 communicates with processor 12 and system memory 24 using PCI Express.

In yet another embodiment, the graphics processor 16 may be part of the chipset (not shown in FIG. 3). Some system architectures today integrate graphics controller 16 with the chipset, so no AGP, PCI or PCI-Express bus is involved. Some of these integrated solutions use main memory instead of dedicated frame buffer for memory. In one such embodiment, the image stored in memory 24 is compressed and stored back into memory 24 before being transferred to the remote client.

Other peripheral interconnect schemes could be used as well.

As noted above, graphics processor 16 performs the complex compression algorithms and pixel read-back used for remote computing. In one embodiment, one or more codecs is used. Other compression algorithms (e.g., wavelets or run-length-encoding) may be used in place of or in addition to JPEG. In one embodiment a mix of codecs is used both for compression and decompression.

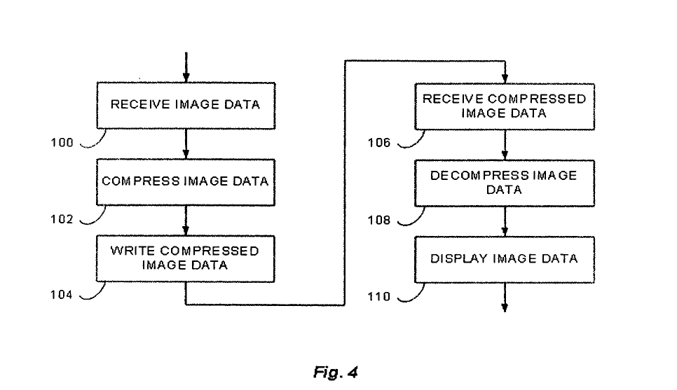

FIG. 4 illustrates a method of compressing image data within computer 34 for transmission to client device 30. At 100, graphics processor 16 receives raster (e.g. image) data for a remote computing session executing on host computer 34. At 102, graphics processor 16 compresses the raster data using software executing within graphics processor 16. Upon completion of the image processing steps, the compressed pixel blocks are returned to the host or the networking controller for transmission over standard networking lines. Transmission over standard networking lines may enable fast computation. Further, this may allow the host to run at a high performance level.

At 104, the compressed raster data is transmitted to the client device 30. At 106, the compressed image data is received by client device 30, where it is decompressed at 108 before being displayed at 110.

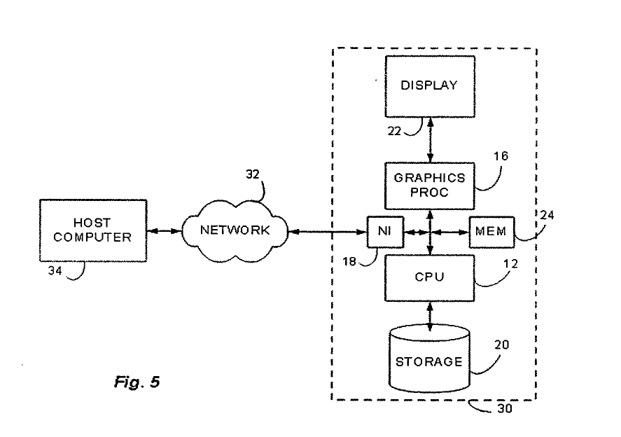

A graphics processor may be used in the decompression process as well. One such embodiment is shown in FIG. 5. In the client device 30 of FIG. 5, a processor 12 is connected to graphics processor 16, a network interface 18, storage device 20 and system memory 24. Network interface 18 is connected to network 32. In one embodiment, processor 12 communicates with network interface 18 and storage device 20 over a Peripheral Component Interconnect (PCI) bus.

In one embodiment, graphics processor 16 is connected to display 22 and local memory 26 and communicates with processor 12 and system memory 24 through an Accelerated Graphics Port (AGP). In another embodiment, graphics processor 16 communicates with processor 12 and system memory 24 using PCI Express. Other peripheral interconnect schemes could be used as well.

In the embodiment shown, host computer 34 compresses raster data before transmitting the raster data to client device 30. In one embodiment, compression is performed via a graphics processor executing compression software. In another embodiment, processor 12 executes such software.

As illustrated in the context of FIG. 4, graphics processor 16 receives the compressed image data at 106, performs decompression at 108 and displays the result on display 22 at 110. Once again, graphics processor 16 may be part of a chipset (e.g., integrated graphics solutions such as described above).

The approach described above allows higher performance remote computing without special purpose hardware and substantially without stealing cycles from the host computer. Performance for remote computing may thereby be maximized, while costs may be minimized. In addition, remote clients may be made more simply, with lower power and at a lower cost by offloading the decompression work from the CPU to the graphics processor.

In the above discussion, the term “computer” is defined to include any digital or analog data processing unit having a programmable graphics processor separate from the main processor. Examples include personal computers, workstations, set top boxes, mainframes, servers, supercomputers and laptops.

Examples of articles comprising computer readable media are floppy disks, hard drives, CD-ROM or DVD media or any other read-write or read-only memory device.

The above description is illustrative, and not restrictive. Many other embodiments will be apparent to those of skill in the art upon reviewing the above description.

The Abstract is provided to comply with 37 C.F.R. § 1.72(b) to allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Thus the following claims are hereby incorporated into the Description of the Embodiments, with each claim standing on its own as a separate example embodiment.

1. A method comprising:
receiving, at a graphics processor of a host computer, image data for a remote computing session executing on the host computer, wherein the host computer includes a central processing unit connected to the graphics processor;
compressing the image data using software executing on the graphics processor;
transmitting the compressed image data to a client device coupled to the host computer over a network;
decompressing the compressed image data; and
displaying an image representative of the decompressed image data.

2. The method of claim 1, wherein compressing the image data includes compressing the image data using codecs.

3. The method of claim 1, wherein the image data includes raster data.

4. The method of claim 3, wherein compressing the image data includes compressing the raster data using one or more codecs.

5. An article comprising a computer readable medium having instructions thereon, wherein the instructions, when executed in a computer, create a system for executing the method of claim 1.

6. A method comprising:
receiving, at a graphics processor of a host computer, compressed image data representative of data transmitted from the host computer, wherein the host computer is remotely coupled to a client device over a network, wherein the host computer includes a central processing unit connected to the graphics processor;
decompressing the compressed image data, wherein decompressing includes:
storing the compressed image data to memory accessible by the graphics processor; and
decompressing the compressed image data by executing instructions within the graphics processor; and
displaying an image representative of the decompressed imager data.

7. The method of claim 6, wherein decompressing the compressed image data includes decompressing the compressed image data using one or more codecs.

8. The method of claim 6, wherein the compressed image data includes raster data.

9. The method of claim 8, wherein decompressing the compressed image data includes decompressing the compressed image data using one or more codecs.

10. An article comprising a computer readable medium having instructions thereon, wherein the instructions, when executed in a computer, create a system for executing the method of claim 7.

11. A computer comprising:
a main processor on which first software is executed, the first software operable to cause the main processor to establish a remote computing session that generates a display image; and
a graphics processor on which second software is executed, the second software operable to cause the graphics processor to compress at least a portion of the display image; and
a display to receive and to display the compressed raster data.

12. The computer of claim 12, wherein the second software includes software for compressing the image data using one or more codecs.

13. The computer of claim 12, wherein the computer further comprises a network interface, wherein the network interface receives user input from the device and forwards the received user input to the first software executing on the main processor.

14. The computer of claim 12, wherein the image data includes raster data.

15. The computer of claim 14, wherein the image data is compressed using one or more codecs.

16. A client device, comprising:
a display device;
a main processor on which first software is executed, the first software operable to interact with a remote computing session executing on a host computer, wherein the remote computing session executing on the host computer generates a display image and wherein the host computer compresses at least a portion of the display image before transmitting the compressed display image to the device; and
a graphics processor connected to the main processor and to the display device, wherein the graphics processor executes second software, the second software operable to cause the graphics processor to decompress the compressed display image and display the decompressed display image on the display device.

17. The client device of claim 16, wherein the image data is compressed using one or more codecs.

18. The client device of claim 16, wherein the device further comprises a network interface, wherein the network interface receives user input and forwards the received user input to the host computer.

19. The client device of claim 18, wherein the image data includes raster data.

20. The client device of claim 19, wherein the image data is compressed using one or more codecs.

21. A system comprising:
a client device comprising:
a display device;
a client main processor;
a client graphics processor connected to the display device and the main processor; and
a network interface; and
a host computer connected over a network to the network interface of the client device, the host computer comprising:
a host main processor on which first software is executed, the first software operable to cause the main processor to establish a remote computing session that generates a display image; and
a host graphics processor connected to the host main processor, wherein the host graphics processor executes second software, the second software operable to cause the graphics processor to compress at least a portion of the display image;
wherein the client main processor executes software operable to interact with the remote computing session executing on the host computer;
wherein the client device receives the compressed display image from the host computer; and
wherein the client graphics processor executes software operable to cause the client graphics processor to decompress the compressed display image and display the decompressed display image on the display device.

22. The system of claim 21, wherein the second software includes software for compressing the image data using one or more codecs.

23. The system of claim 21, wherein the system further comprises a network interface, wherein the network interface receives user input from the device and forwards the received user input to the first software executing on the main processor.

24. The system of claim 21, wherein the image data includes raster data.
